(19) United States
(12) Patent Application Publication
(10) Pub. No.: US 2010/0269060 A1
(43) Pub. Date: Oct. 21, 2010

(54) Navigating A Plurality Of Instantiated Virtual Desktops

(75) Inventors: Justin P. Bandholz, Cary, NC (US); William G. Pagan, Durham, NC (US); William J. Piazza, Holly Springs, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/425,550

(22) Filed: Apr. 17, 2009

(51) Int. Cl. G06F 3/048

(52) U.S. Cl. 715/778

(57) ABSTRACT

Navigating a plurality of instantiated virtual desktops including maintaining a z-axis order of a plurality of currently instantiated virtual desktops; receiving a user's invocation of one or more mouse buttons; identifying the received invocation of the one or more mouse buttons as a user instruction to change the virtual desktop currently given focus; selecting, in dependence upon the user instruction, one of the plurality of virtual desktops to give focus; reordering the virtual desktops in the z-axis such that the selected virtual desktop is highest in the z-axis order; giving focus to the selected virtual desktop; and displaying the selected virtual desktop as highest in the z-axis order.

### BACKGROUND OF THE INVENTION

1. Field of the Invention

The field of the invention is data processing, or, more specifically, methods, apparatus, and products for navigating a plurality of instantiated virtual desktops.

2. Description of Related Art

A virtual desktop is a term used to describe ways in which a computer's desktop environment is expanded through the use of software. A virtual desktop is one of a plurality of GUI desktops and user interfaces available to a user. A virtual desktop manager is a program that allows a computer user to have more than one such virtual desktop available simultaneously on a single computer. Each user interface is called a virtual desktop. Such virtual desktops may be customizable and switchable allowing a user to interact with particular programs through particular virtual desktops. Currently, however, switching among virtual desktops requires unfamiliar input devices, cumbersome keystrokes, or inconvenient user invocations.

### SUMMARY OF THE INVENTION

Navigating a plurality of instantiated virtual desktops including maintaining, by a virtual desktop manager, a z-axis order of a plurality of currently instantiated virtual desktops; receiving a user's invocation of one or more mouse buttons; identifying, by the virtual desktop manager without regard to any mouse pointer location on the display screen associated with the mouse, the received invocation of the one or more mouse buttons as a user instruction to change the virtual desktop currently given focus; selecting, by the virtual desktop manager in dependence upon the user instruction, one of the plurality of virtual desktops to give focus; reordering, by the virtual desktop manager, the virtual desktops in the z-axis such that the selected virtual desktop is highest in the z-axis order; giving focus, by the virtual desktop manager, to the selected virtual desktop; and displaying, by the virtual desktop manager, the selected virtual desktop as highest in the z-axis order.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram illustrating a system for navigating a plurality of instantiated virtual desktops according to embodiments of the present invention.

FIG. 2 sets forth a block diagram illustrating a display screen with three virtual desktops that may be navigated according to embodiments of the present invention.

FIG. 3, by contrast, sets forth a block diagram of a illustrating a display screen that also has three virtual instantiated virtual desktops that may be navigated according to embodiments of the present invention.

FIG. 4 sets forth a block diagram illustrating a display screen that also has three instantiated virtual desktops that may be navigated according to embodiments of the present invention.

FIG. 5 sets forth a flow chart illustrating an example method for navigating a plurality of instantiated virtual desktops according to embodiments of the present invention.

FIG. 6 sets forth a flow chart illustrating a further example method for navigating a plurality of instantiated virtual desktops according to embodiments of the present invention.

FIG. 7 sets forth a flow chart illustrating a further example method for navigating a plurality of instantiated virtual desktops according to embodiments of the present invention.

FIG. 8 sets forth a flow chart illustrating a further example method for navigating a plurality of instantiated virtual desktops according to embodiments of the present invention.

FIG. 9 sets forth a flow chart illustrating a further example method for navigating a plurality of instantiated virtual desktops according to embodiments of the present invention.

FIG. 10 sets forth a flow chart illustrating a further example method for navigating a plurality of instantiated virtual desktops according to embodiments of the present invention.

### DETAILED DESCRIPTION OF EXAMPLE EMBODIMENTS

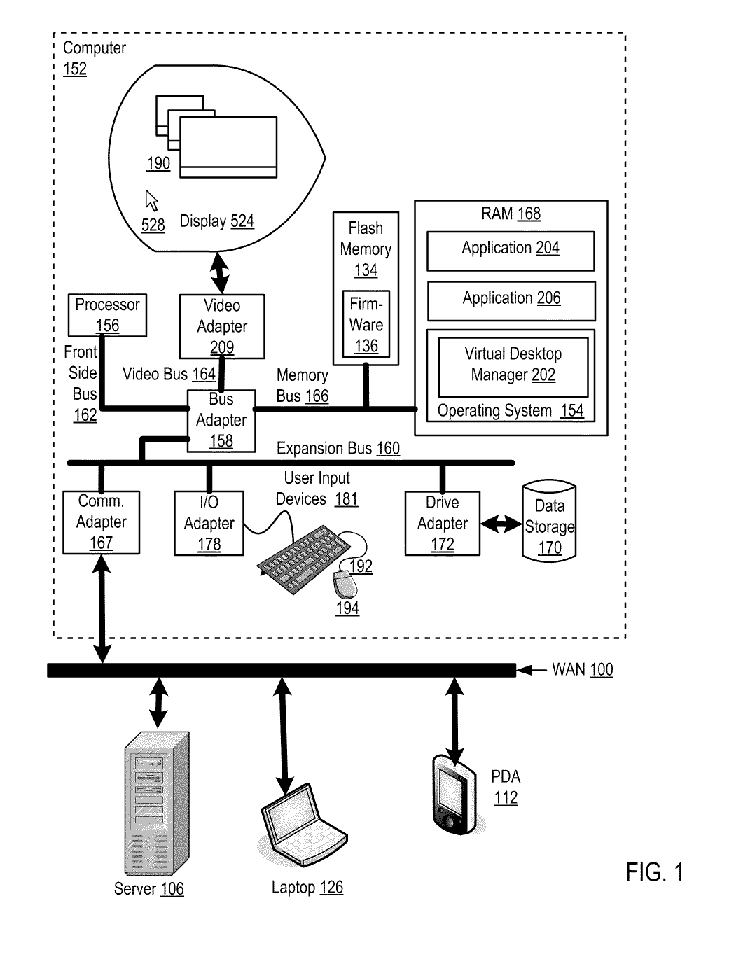

Example methods, apparatus, and computer program products for navigating a plurality of instantiated virtual desktops in accordance with the present invention are described with reference to the accompanying drawings, beginning with FIG. 1. FIG. 1 sets forth a block diagram illustrating a system for navigating a plurality of instantiated virtual desktops according to embodiments of the present invention. The system of FIG. 1 is generally capable of maintaining, by a virtual desktop manager (202), a z-axis order of a plurality of currently instantiated virtual desktops (190); receiving a user's invocation of one or more mouse buttons (192); identifying, by the virtual desktop manager (202) without regard to any mouse pointer location (528) on the display screen (524) associated with the mouse (194), the received invocation of the one or more mouse buttons (194) as a user instruction to change the virtual desktop currently given focus; selecting, by the virtual desktop manager (202) in dependence upon the user instruction, one of the plurality of virtual desktops to give focus; reordering, by the virtual desktop manager (202), the virtual desktops (190) in the z-axis such that the selected virtual desktop is highest in the z-axis order; giving focus, by the virtual desktop manager (202), to the selected virtual desktop; and displaying, by the virtual desktop manager (202), the selected virtual desktop as highest in the z-axis order.

Navigating a plurality of instantiated virtual desktops in accordance with the present invention is generally implemented with computers, that is, with automated computing machinery. The system of FIG. 1 includes a computer (152) useful in navigating a plurality of instantiated virtual desktops according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an operating system (154). Operating systems that support virtual desktops or are capable of extension to support virtual desktops and are therefore capable of modification to support navigating a plurality of instantiated virtual desktops according to embodiments of the present invention include UNIX™, Linux , Microsoft XP™, AIX™, IBM's i5/OS™, and others as will occur to those of skill in the art.

The example operating system (154) of FIG. 1 includes a virtual desktop manager (202), a module of automated computing machinery capable of maintaining a z-axis order of a plurality of currently instantiated virtual desktops (190); receiving a user's invocation of one or more mouse buttons (192); identifying, without regard to any mouse pointer location (528) on the display screen (524) associated with the mouse (194), the received invocation of the one or more mouse buttons (192) as a user instruction to change the virtual desktop currently given focus; selecting, in dependence upon the user instruction, one of the plurality of virtual desktops to give focus; reordering the virtual desktops (190) in the z-axis such that the selected virtual desktop is highest in the z-axis order; giving focus to the selected virtual desktop; and displaying the selected virtual desktop as highest in the z-axis order.

Also stored in RAM (168) are two applications (204) and (206) each capable of being independently displayed in one of the plurality of virtual desktops (190). The operating system (154), the virtual desktop manager (202) and the applications (204 and 206) in the example of FIG. 1 are shown in RAM (168), but many components of such automated computing machinery typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for useful in embodiments of the present invention include Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens (524), as well as user input from user input devices (181) such as keyboards and mice (194). Navigating a plurality of instantiated virtual desktops according to embodiments of the present invention includes receiving a user's invocation of one or more mouse buttons (192) and identifying, by the virtual desktop manager (202) the received invocation of the one or more mouse buttons as a user instruction to change the virtual desktop currently given focus. The virtual desktop given focus is the virtual desktop with which interaction is possible either by use of a keyboard, mouse, or other user input device.

The invocation of the one or more mouse buttons (192) to change the virtual desktop currently given focus may include any number of combination of mouse clicks or duration of mouse clicks. The combination of mouse clicks or duration of mouse clicks are typically implemented as combinations of mouse clicks or durations of mouse clicks that do not currently invoke other functionality by the operating system such as opening files, moving or copying files, and so on. For example, in some embodiments of the present invention, the invocation of the one or more mouse buttons (192) may include holding one mouse button for a threshold duration, a combination of single and double clicks of a single mouse button, a communication of one or more mouse clicks of more than one mouse button, holding more than one mouse button together for a threshold duration, or any other invocation of one or more mouse buttons that will occur to those of skill in the art.

The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus. To effect the display of the selected virtual desktop and dynamic transition to the selected virtual desktop given focus according to embodiments of the present invention the virtual desktop manager may make calls to an application programming interface (‘API’) for the video adapter (209).

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for navigating a plurality of instantiated virtual desktops according to embodiments of the present invention include modems for wired dial-up communications, Ethernet (IEEE 802.3) adapters for wired data communications network communications, and 802.11 adapters for wireless data communications network communications.

The computer (152) of FIG. 1 is coupled for data communications through a WAN (100) to a server (106), a laptop (126), and a PDA (112). The arrangement of servers and other devices making up the example system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

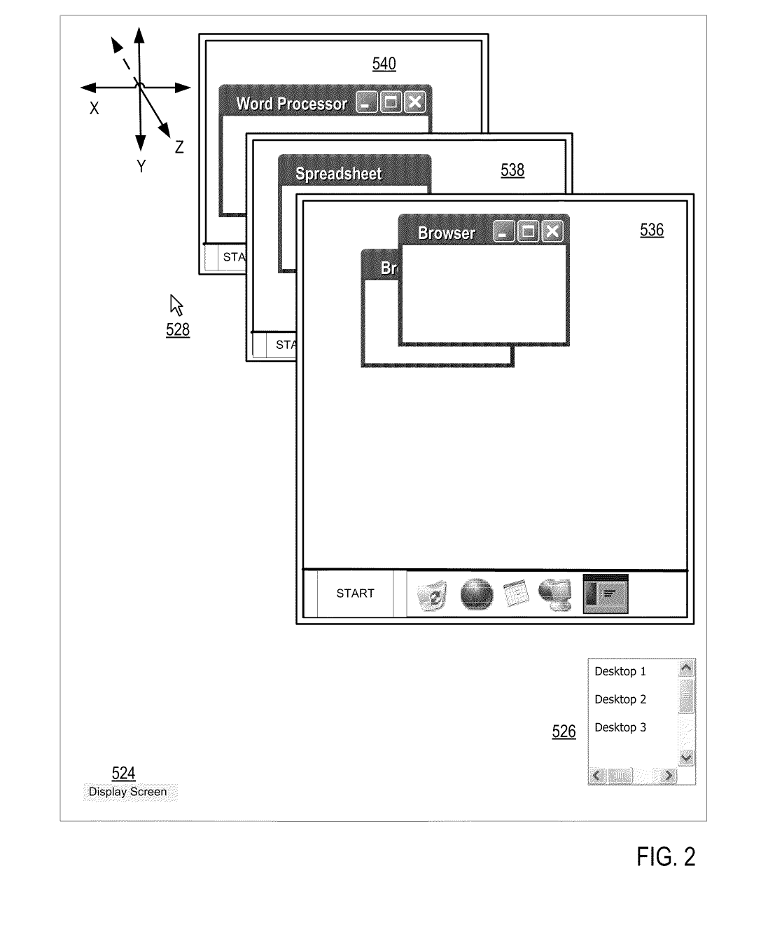

For further explanation, FIG. 2 sets forth a block diagram illustrating a display screen (524) with three virtual desktops that may be navigated according to embodiments of the present invention. The display screen (524) of FIG. 2 has an x-axis, a y-axis, and a z-axis order. The x-axis runs horizontally along the display screen, the y-axis runs vertically along the display screen and is perpendicular to the x-axis, and the z-axis runs perpendicular to both the x-axis and the y-axis into and out of the display screen. The term ‘highest’ in the z-axis order refers to the virtual desktop given focus and displayed in a manner to simulate that virtual desktop as being closer to the viewer of the display screen.

In the example of FIG. 2, the display screen (524) includes three virtual desktops (536, 538, and 540). Virtual desktop (536) highest in the z-axis order followed by virtual desktop (538) and lowest in z-axis order is virtual desktop (540). Virtual desktop (540) has displayed within it a running word processor, virtual desktop (538) has displayed within it a spreadsheet, and virtual desktop (536) has displayed within it two instances of a browser application.

In the example of FIG. 2 a GUI widget (526) displays the current z-axis order of the virtual desktops (536, 538, and 540). The current z-axis order is displayed in a GUI widget in the example of FIG. 2 for explanation and not for limitation. In fact, displaying the current z-axis order of the virtual desktops (536, 538, and 540) may be carried out in many ways such as through the use of icons, displaying the virtual desktops with an effect of translucency, lists, or any other way of displaying the current z-axis order of the virtual desktops that will occur to those of skill in the art.

In the example of FIG. 2 a user is empowered to navigate between the virtual desktops by invoking one or more mouse buttons. In the example of FIG. 2, the mouse pointer (528) does not point at any of the virtual desktops (536, 538, and 540). Navigating between the virtual desktops (536, 538, and 540) occurs in the example of FIG. 2 without regard to any mouse pointer location on the display screen associated with the mouse. That is, only the combination of one or more mouse clicks dictates which virtual desktop (540 and 538) will be given focus and brought to highest in the z-axis order.

In the example of FIG. 2, all three instantiated virtual desktops (536, 538, and 540) are visibly displayed on the GUI display screen (524). In some embodiments of the present invention, virtual desktops that are not highest in z-axis order are displayed with less clarity than the virtual desktop highest in the z-axis order and currently given focus. In such embodiments, a user may be able to see each of the virtual desktops without obscuring the use of the virtual desktop highest in z-axis order and currently given focus.

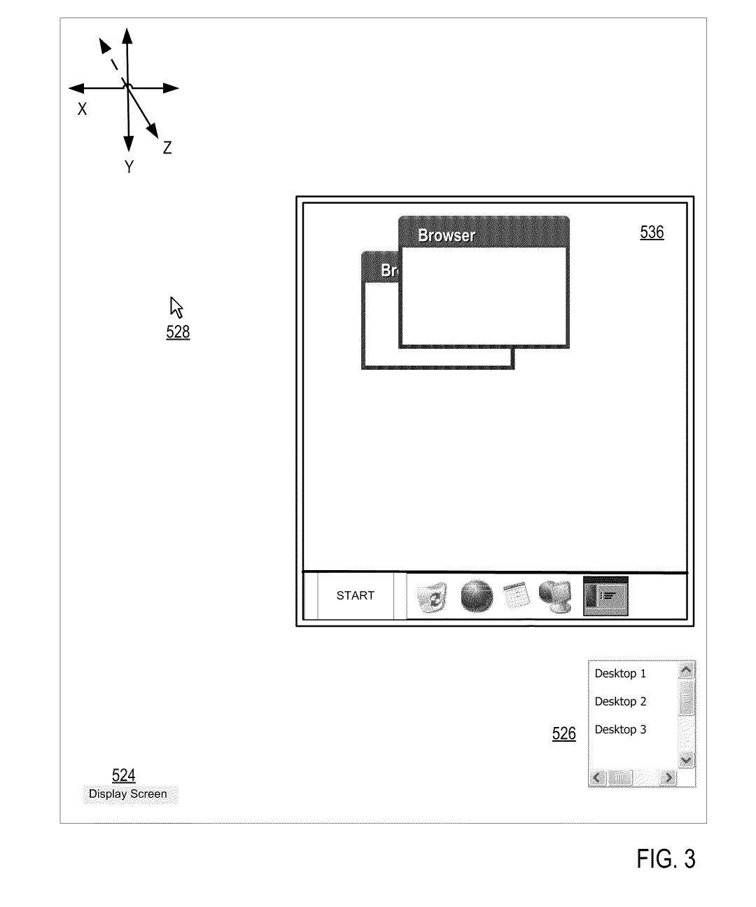

As just mentioned above, in the example of FIG. 2 all of the instantiated virtual desktops are visibly displayed on the GUI display screen (524). FIG. 3, by contrast, sets forth a block diagram of a illustrating a display screen that also has three virtual instantiated virtual desktops that may be navigated according to embodiments of the present invention. In the example of FIG. 3, only the virtual desktop (536) that is highest in the z-axis order and currently given focus is visibly displayed on the GUI display screen (524). To aid a user in navigating the instantiated virtual desktops according to embodiments of the present invention, identifications of each of the virtual desktops are displayed in z-axis order in a GUI display box (526). In the example of FIG. 3, the virtual desktop identifications are numerical names, ‘desktop 1,’ ‘desktop 2,’ and ‘desktop 3.’ These identifications are for explanation and not for limitation. In fact, virtual desktops that may be navigated according to embodiments of the present invention may be given more descriptive names, such as by allowing a user to name each desktop, identifying the desktop by the applications displayed in the virtual desktops, or in any other way that will occur to those of skill in the art.

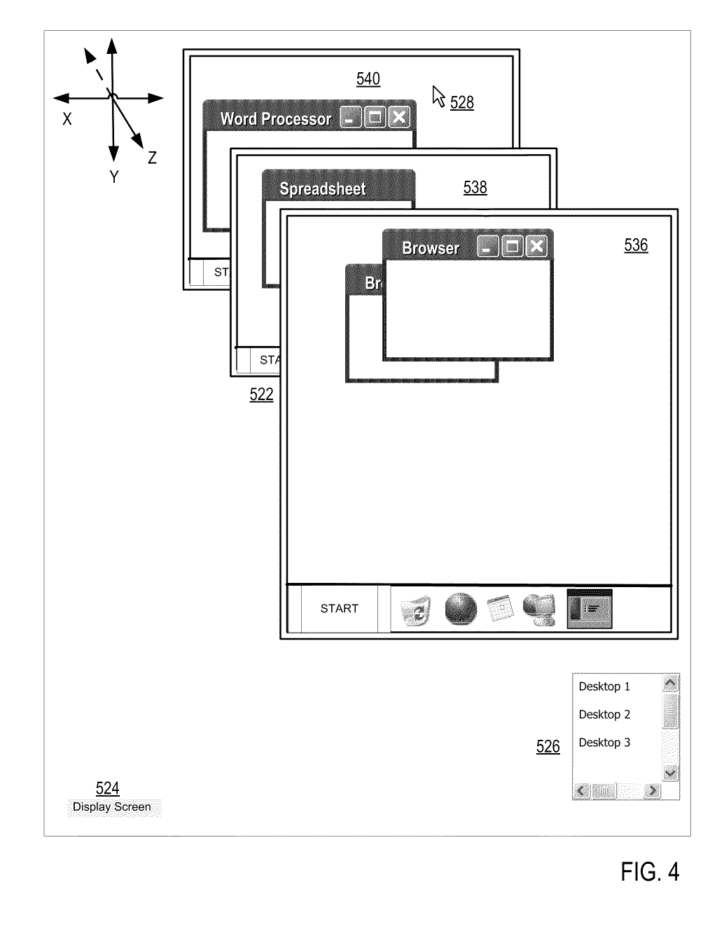

As mentioned above, identifying the received invocation of the one or more mouse buttons as a user instruction to change the virtual desktop currently given focus is carried out without regard to any mouse pointer location on the display screen associated with the mouse. That is, only the invocation of the one or more mouse buttons is identified as an instruction to change the virtual desktop currently given focus. In some embodiments, however, the current mouse pointer location on the display screen may be used to identify which virtual desktop to give focus and bring to highest in the z-axis order. For further explanation, therefore, FIG. 4 sets forth a block diagram illustrating a display screen that also has three instantiated virtual desktops that may be navigated according to embodiments of the present invention. In the example of FIG. 3, the mouse pointer location on the display screen points to virtual desktop (540). Navigating the instantiated virtual desktops (536, 538, and 540) according to the present invention may include identifying the received invocation of the one or more mouse buttons as a user instruction to change the virtual desktop currently given focus and selecting in dependence upon the user instruction the virtual desktop (540) identified by the mouse pointer location (528) to give focus. In the example of FIG. 3, therefore, the virtual desktop (540) which is lowest in z-axis order is identified by the mouse pointer location (528) and is selected, given focus and displayed as highest in the z-axis order.

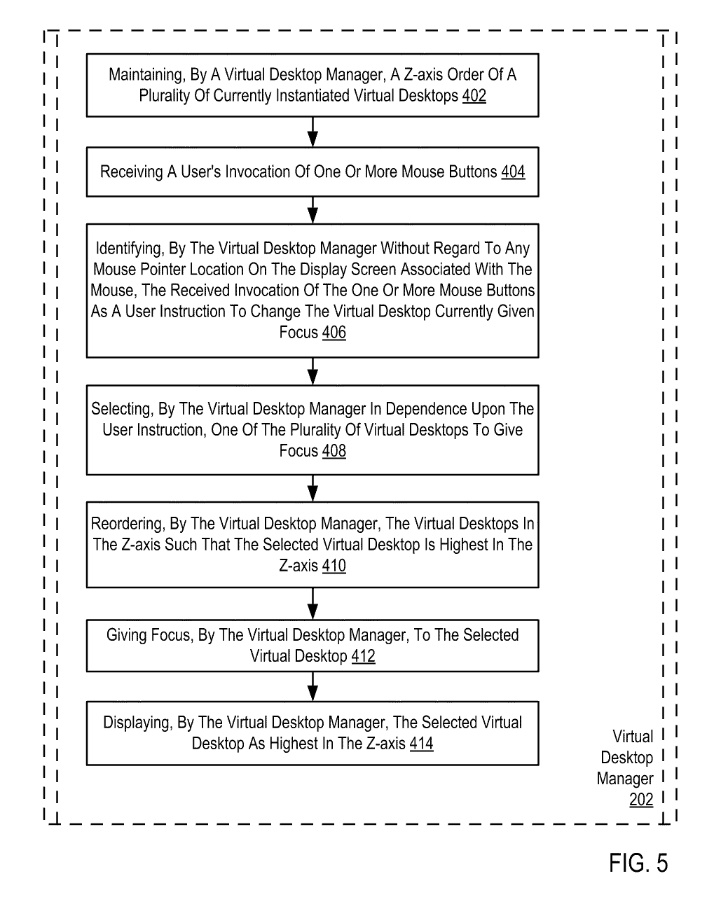

For further explanation, FIG. 5 sets forth a flow chart illustrating an example method for navigating a plurality of instantiated virtual desktops according to embodiments of the present invention. The method of FIG. 5 includes that includes maintaining (402), by a virtual desktop manager, a z-axis order of a plurality of currently instantiated virtual desktops. Maintaining (402), by a virtual desktop manager, a z-axis order of a plurality of currently instantiated virtual desktops may be carried out by storing identifications of each of the currently instantiated virtual desktops according to a data structure such as a list. In the example of FIG. 5 the virtual desktop having focus is the virtual desktop highest in the z-axis order.

The method of FIG. 5 also includes receiving (404) a user's invocation of one or more mouse buttons. The invocation of the one or more mouse buttons to change the virtual desktop currently given focus and highest in z-axis order may include any number of combination of mouse clicks or duration of mouse clicks. Typically, the combination of mouse clicks or duration of mouse clicks are implemented as combinations of mouse clicks or durations of mouse clicks that do not currently invoke other functionality by the operating system such as opening files, moving or copying files, and so on. For example, in some embodiments of the present invention, the invocation of the one or more mouse buttons may include holding one mouse button for a threshold duration, a combination of single and double clicks of a single mouse button, a communication of one or more mouse clicks of more than one mouse button, holding more than one mouse button together for a threshold duration, or any other invocation of one or more mouse buttons that will occur to those of skill in the art.

The method of FIG. 5 also includes identifying (406), by the virtual desktop manager without regard to any mouse pointer location on the display screen associated with the mouse, the received invocation of the one or more mouse buttons as a user instruction to change the virtual desktop currently given focus. Identifying (406) the received invocation of the one or more mouse buttons as a user instruction to change the virtual desktop currently given focus may be carried out through an event listener such as a mouse listener.

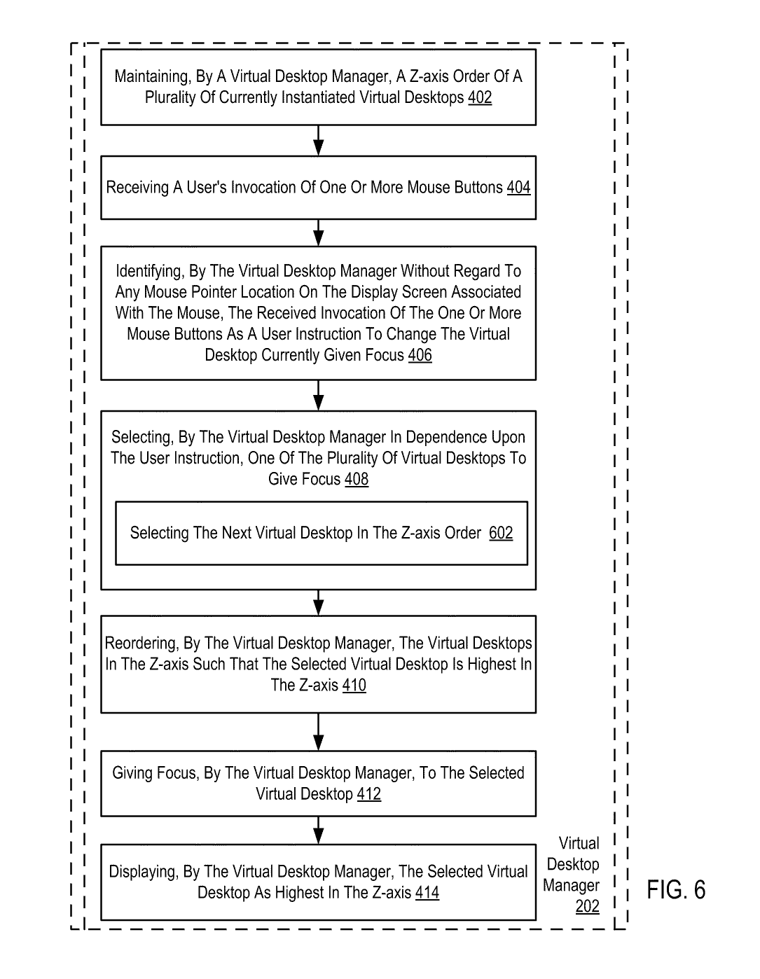

The method of FIG. 5 also includes selecting (408), by the virtual desktop manager in dependence upon the user instruction, one of the plurality of virtual desktops to give focus. In some embodiments of the present invention, selecting, by the virtual desktop manager in dependence upon the user instruction, one of the plurality of virtual desktops to give focus may be carried out by selecting the next virtual desktop in the z-axis order, selecting a virtual desktop that is not the next virtual desktop in the z-axis order in dependence upon a virtual desktop selection rule, or selecting one of the plurality of virtual desktops to give focus in dependence upon mouse pointer location on the display screen as discussed below with reference to FIGS. 6-8.

The method of FIG. 5 also includes reordering (410), by the virtual desktop manager, the virtual desktops in the z-axis such that the selected virtual desktop is highest in the z-axis order. Reordering (410), by the virtual desktop manager, the virtual desktops in the z-axis such that the selected virtual desktop is highest in the z-axis may be carried out by ordering the virtual desktops according to a predetermined rule such as by swapping the positions in z-axis order of the virtual desktop given focus and the virtual desktop previously having focus, moving the virtual desktop previously having focus to lowest in the z-axis order, moving the virtual desktop previously having focus to second highest in z-axis order, or any other way of reordering the virtual desktops that will occur to those of skill in the art.

The method of FIG. 5 also includes giving focus (412), by the virtual desktop manager, to the selected virtual desktop. The virtual desktop given focus is the virtual desktop with which interaction is possible either by use of a keyboard, mouse, or other user input device.

The method of FIG. 5 also includes displaying (414), by the virtual desktop manager, the selected virtual desktop as highest in the z-axis order. Displaying (414), by the virtual desktop manager, the selected virtual desktop as highest in the z-axis may be carried out through an API call to the graphics adapter for the display screen.

For further explanation, FIG. 6 sets forth a flow chart illustrating a further example method for navigating a plurality of instantiated virtual desktops according to embodiments of the present invention. The method of FIG. 6 is similar to the method of FIG. 5 in that the method of FIG. 6 includes maintaining (402), by a virtual desktop manager, a z-axis order of a plurality of currently instantiated virtual desktops; receiving (404) a user's invocation of one or more mouse buttons; identifying (406), by the virtual desktop manager without regard to any mouse pointer location on the display screen associated with the mouse, the received invocation of the one or more mouse buttons as a user instruction to change the virtual desktop currently given focus; selecting (408), by the virtual desktop manager in dependence upon the user instruction, one of the plurality of virtual desktops to give focus; reordering (410), by the virtual desktop manager, the virtual desktops in the z-axis such that the selected virtual desktop is highest in the z-axis order; giving focus (412), by the virtual desktop manager, to the selected virtual desktop; and displaying (414), by the virtual desktop manager, the selected virtual desktop as highest in the z-axis order.

In the method of FIG. 6, however, selecting (408), by the virtual desktop manager in dependence upon the user instruction, one of the plurality of virtual desktops to give focus includes selecting (602) the next virtual desktop in the z-axis order. Selecting the next virtual desktop in z-axis order allows a user to simply make the invocation of one or more mouse buttons and have displayed on at a time all the instantiated desktops. In such an embodiment, a user may continue to select the next virtual desktop until the desired virtual desktop is given focus and displayed.

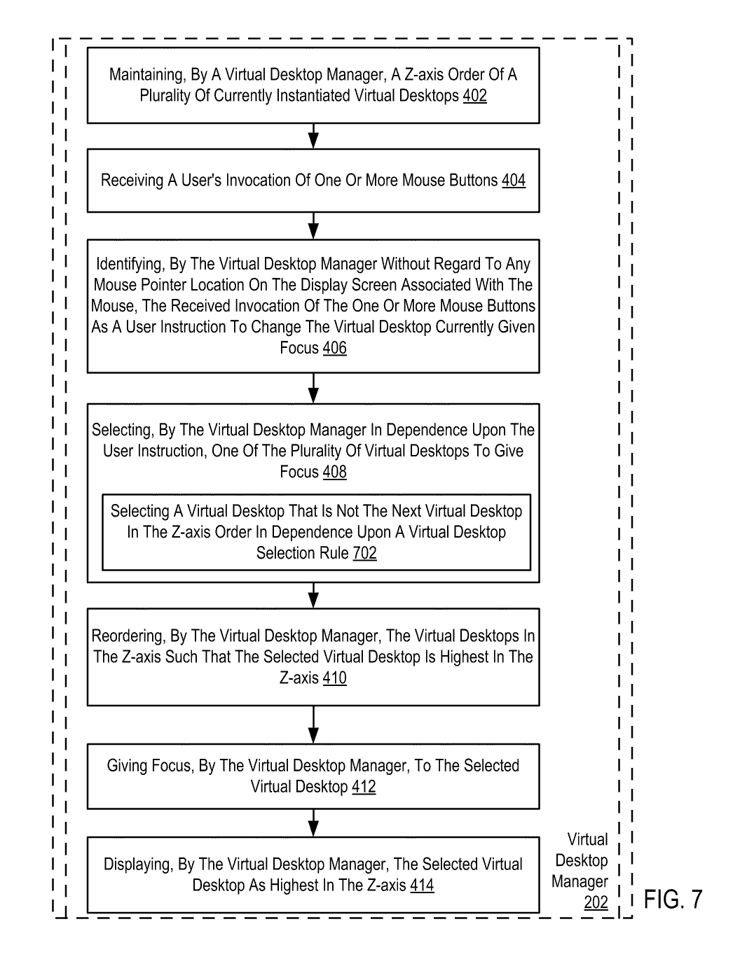

For further explanation, FIG. 7 sets forth a flow chart illustrating a further example method for navigating a plurality of instantiated virtual desktops according to embodiments of the present invention. The method of FIG. 7 is similar to the method of FIG. 5 in that the method of FIG. 7 includes maintaining (402), by a virtual desktop manager, a z-axis order of a plurality of currently instantiated virtual desktops; receiving (404) a user's invocation of one or more mouse buttons; identifying (406), by the virtual desktop manager without regard to any mouse pointer location on the display screen associated with the mouse, the received invocation of the one or more mouse buttons as a user instruction to change the virtual desktop currently given focus; selecting (408), by the virtual desktop manager in dependence upon the user instruction, one of the plurality of virtual desktops to give focus; reordering (410), by the virtual desktop manager, the virtual desktops in the z-axis such that the selected virtual desktop is highest in the z-axis order; giving focus (412), by the virtual desktop manager, to the selected virtual desktop; and displaying (414), by the virtual desktop manager, the selected virtual desktop as highest in the z-axis order.

In the method of FIG. 7, however, selecting (408), by the virtual desktop manager in dependence upon the user instruction, one of the plurality of virtual desktops to give focus includes selecting (702) a virtual desktop that is not the next virtual desktop in the z-axis order in dependence upon a virtual desktop selection rule. A virtual desktop selection rule dictates which virtual desktop is to be given focus. Such a selection rule may include a rule to select the lowest virtual desktop in z-axis order to give focus, select the virtual desktop identified by a unique set of mouse button invocations, or any other rule that will occur to those of skill in the art.

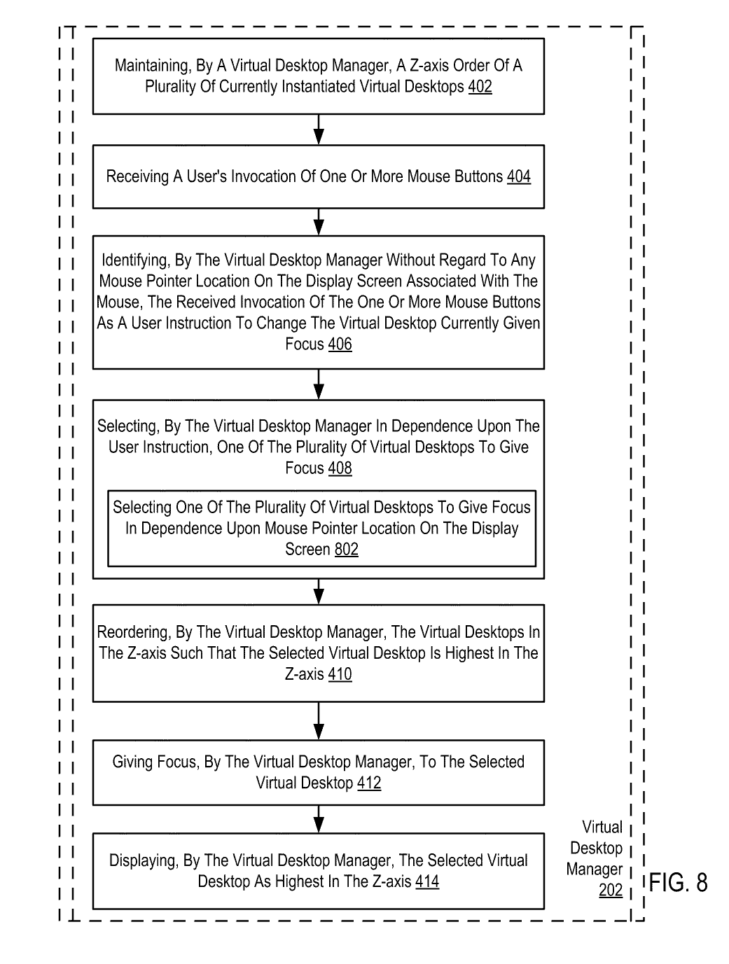

For further explanation, FIG. 8 sets forth a flow chart illustrating a further example method for navigating a plurality of instantiated virtual desktops according to embodiments of the present invention. The method of FIG. 8 is similar to the method of FIG. 5 in that the method of FIG. 8 includes maintaining (402), by a virtual desktop manager, a z-axis order of a plurality of currently instantiated virtual desktops; receiving (404) a user's invocation of one or more mouse buttons; identifying (406), by the virtual desktop manager without regard to any mouse pointer location on the display screen associated with the mouse, the received invocation of the one or more mouse buttons as a user instruction to change the virtual desktop currently given focus; selecting (408), by the virtual desktop manager in dependence upon the user instruction, one of the plurality of virtual desktops to give focus; reordering (410), by the virtual desktop manager, the virtual desktops in the z-axis such that the selected virtual desktop is highest in the z-axis order; giving focus (412), by the virtual desktop manager, to the selected virtual desktop; and displaying (414), by the virtual desktop manager, the selected virtual desktop as highest in the z-axis order.

In the method of FIG. 8, however, selecting (408), by the virtual desktop manager in dependence upon the user instruction, one of the plurality of virtual desktops to give focus includes selecting (802) one of the plurality of virtual desktops to give focus in dependence upon mouse pointer location on the display screen. In such an embodiment, a user is empowered to select which virtual desktop is to be given focus by pointing the mouse pointer either at a visual display of the virtual desktop or by pointing to an identification or icon representing the virtual desktop.

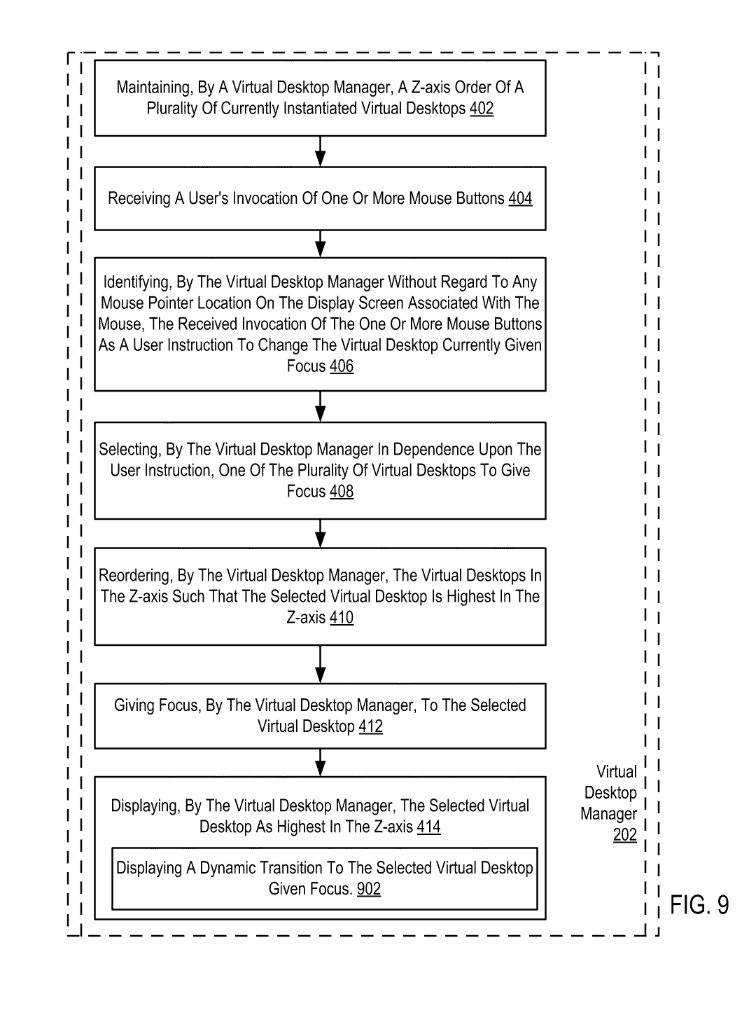

For further explanation, FIG. 9 sets forth a flow chart illustrating a further example method for navigating a plurality of instantiated virtual desktops according to embodiments of the present invention. The method of FIG. 9 is similar to the method of FIG. 5 in that the method of FIG. 9 includes maintaining (402), by a virtual desktop manager, a z-axis order of a plurality of currently instantiated virtual desktops; receiving (404) a user's invocation of one or more mouse buttons; identifying (406), by the virtual desktop manager without regard to any mouse pointer location on the display screen associated with the mouse, the received invocation of the one or more mouse buttons as a user instruction to change the virtual desktop currently given focus; selecting (408), by the virtual desktop manager in dependence upon the user instruction, one of the plurality of virtual desktops to give focus; reordering (410), by the virtual desktop manager, the virtual desktops in the z-axis such that the selected virtual desktop is highest in the z-axis order; giving focus (412), by the virtual desktop manager, to the selected virtual desktop; and displaying (414), by the virtual desktop manager, the selected virtual desktop as highest in the z-axis order.

In the method of FIG. 9, however, displaying, by a virtual desktop manager, the selected desktop as highest in the z-axis further comprises displaying a dynamic transition to the selected virtual desktop given focus. Such a dynamic transition to the selected virtual desktop given focus may be carried out by making a call to an API for a video adapter. Such a dynamic transition may include fading-out of the display of the virtual desktop previously having focus and fading-in the display of the virtual desktop currently having focus.

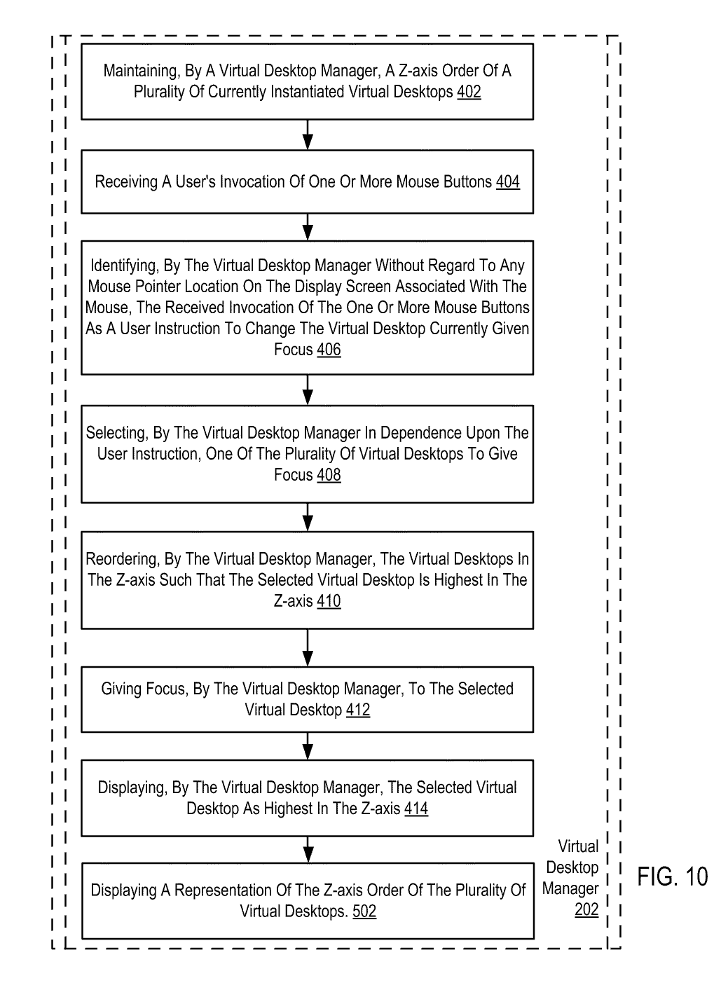

For further explanation, FIG. 10 sets forth a flow chart illustrating a further example method for navigating a plurality of instantiated virtual desktops according to embodiments of the present invention. The method of FIG. 10 is similar to the method of FIG. 5 in that the method of FIG. 10 includes maintaining (402), by a virtual desktop manager, a z-axis order of a plurality of currently instantiated virtual desktops; receiving (404) a user's invocation of one or more mouse buttons; identifying (406), by the virtual desktop manager without regard to any mouse pointer location on the display screen associated with the mouse, the received invocation of the one or more mouse buttons as a user instruction to change the virtual desktop currently given focus; selecting (408), by the virtual desktop manager in dependence upon the user instruction, one of the plurality of virtual desktops to give focus; reordering (410), by the virtual desktop manager, the virtual desktops in the z-axis such that the selected virtual desktop is highest in the z-axis order; giving focus (412), by the virtual desktop manager, to the selected virtual desktop; and displaying (414), by the virtual desktop manager, the selected virtual desktop as highest in the z-axis order.

In the method of FIG. 10, however, navigating a plurality of instantiated virtual desktops also includes displaying (502) a representation of the z-axis order of the plurality of virtual desktops. Displaying (502) a representation of the z-axis order of the plurality of virtual desktops may be carried out by displaying identifications of the virtual desktops in a GUI widget, displaying identifications of the virtual desktops in a list, displaying icons representing the virtual desktops, displaying the virtual desktops themselves with an effect of translucency, or any other way of displaying a representation of the z-axis order of the plurality of virtual desktops that will occur to those of skill in the art.

Example embodiments of the present invention are described largely in the context of a fully functional computer system for navigating a plurality of instantiated virtual desktops. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the example embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of navigating a plurality of instantiated virtual desktops, the method comprising:
maintaining, by a virtual desktop manager, a z-axis order of a plurality of currently instantiated virtual desktops;
wherein the virtual desktop having focus is the virtual desktop highest in the z-axis order;
wherein the virtual desktop manager comprises a module of automated computing machinery;
receiving a user's invocation of one or more mouse buttons;
identifying, by the virtual desktop manager without regard to any mouse pointer location on the display screen associated with the mouse, the received invocation of the one or more mouse buttons as a user instruction to change the virtual desktop currently given focus;
selecting, by the virtual desktop manager in dependence upon the user instruction, one of the plurality of virtual desktops to give focus;
reordering, by the virtual desktop manager, the virtual desktops in the z-axis such that the selected virtual desktop is highest in the z-axis order;
giving focus, by the virtual desktop manager, to the selected virtual desktop; and
displaying, by the virtual desktop manager, the selected virtual desktop as highest in the z-axis order.

2. The method of claim 1 further comprising displaying a representation of the z-axis order of the plurality of virtual desktops.

3. The method of claim 1 wherein selecting, by the virtual desktop manager in dependence upon the user instruction, one of the plurality of virtual desktops to give focus further comprises selecting the next virtual desktop in the z-axis order.

4. The method of claim 1 wherein selecting, by the virtual desktop manager in dependence upon the user instruction, one of the plurality of virtual desktops to give focus further comprises selecting a virtual desktop that is not the next virtual desktop in the z-axis order in dependence upon a virtual desktop selection rule.

5. The method of claim 1 wherein selecting, by the virtual desktop manager in dependence upon the user instruction, one of the plurality of virtual desktops to give focus further comprises selecting one of the plurality of virtual desktops to give focus in dependence upon mouse pointer location on the display screen.

6. The method of claim 1 wherein the invocation by a user of one or more mouse buttons includes depressing one or more of the mouse buttons for a threshold period of time.

7. The method of claim 1 wherein the invocation by a user of one or more mouse buttons includes a predetermined collection of mouse clicks.

8. The method of claim 1 wherein displaying, by a virtual desktop manager, the selected desktop as highest in the z-axis further comprises displaying a dynamic transition to the selected virtual desktop given focus.

9. Apparatus for navigating a plurality of instantiated virtual desktops, the apparatus comprising a computer processor, a computer memory operatively coupled to the computer processor, the computer memory having disposed within it computer program instructions capable of:
maintaining, by a virtual desktop manager, a z-axis order of a plurality of currently instantiated virtual desktops;
wherein the virtual desktop having focus is the virtual desktop highest in the z-axis order;
wherein the virtual desktop manager comprises a module of automated computing machinery;
receiving a user's invocation of one or more mouse buttons;
identifying, by the virtual desktop manager without regard to any mouse pointer location on the display screen associated with the mouse, the received invocation of the one or more mouse buttons as a user instruction to change the virtual desktop currently given focus;
selecting, by the virtual desktop manager in dependence upon the user instruction, one of the plurality of virtual desktops to give focus;
reordering, by the virtual desktop manager, the virtual desktops in the z-axis such that the selected virtual desktop is highest in the z-axis order;
giving focus, by the virtual desktop manager, to the selected virtual desktop; and
displaying, by the virtual desktop manager, the selected virtual desktop as highest in the z-axis order.

10. The apparatus of claim 9 wherein the computer memory has disposed within it computer program instructions capable of displaying a representation of the z-axis order of the plurality of virtual desktops.

11. The apparatus of claim 9 wherein computer program instructions capable of selecting, by the virtual desktop manager in dependence upon the user instruction, one of the plurality of virtual desktops to give focus further comprises computer program instructions capable of selecting the next virtual desktop in the z-axis order.

12. The apparatus of claim 9 wherein computer program instructions capable of selecting, by the virtual desktop manager in dependence upon the user instruction, one of the plurality of virtual desktops to give focus further comprises computer program instructions capable of selecting a virtual desktop that is not the next virtual desktop in the z-axis order in dependence upon a virtual desktop selection rule.

13. The apparatus of claim 9 wherein computer program instructions capable of selecting, by the virtual desktop manager in dependence upon the user instruction, one of the plurality of virtual desktops to give focus further comprises computer program instructions capable of selecting one of the plurality of virtual desktops to give focus in dependence upon mouse pointer location on the display screen.

14. A computer program product for navigating a plurality of instantiated virtual desktops, the computer program product disposed in a signal bearing medium, the computer program product comprising computer program instructions capable of:
maintaining, by a virtual desktop manager, a z-axis order of a plurality of currently instantiated virtual desktops;
wherein the virtual desktop having focus is the virtual desktop highest in the z-axis order;
wherein the virtual desktop manager comprises a module of automated computing machinery;
receiving a user's invocation of one or more mouse buttons;
identifying, by the virtual desktop manager without regard to any mouse pointer location on the display screen associated with the mouse, the received invocation of the one or more mouse buttons as a user instruction to change the virtual desktop currently given focus;
selecting, by the virtual desktop manager in dependence upon the user instruction, one of the plurality of virtual desktops to give focus;
reordering, by the virtual desktop manager, the virtual desktops in the z-axis such that the selected virtual desktop is highest in the z-axis order;
giving focus, by the virtual desktop manager, to the selected virtual desktop; and
displaying, by the virtual desktop manager, the selected virtual desktop as highest in the z-axis order.

15. The computer program product of claim 14 wherein the computer memory has disposed within it computer program instructions capable of displaying a representation of the z-axis order of the plurality of virtual desktops.

16. The computer program product of claim 14 wherein computer program instructions capable of selecting, by the virtual desktop manager in dependence upon the user instruction, one of the plurality of virtual desktops to give focus further comprises computer program instructions capable of selecting the next virtual desktop in the z-axis order.

17. The computer program product of claim 14 wherein computer program instructions capable of selecting, by the virtual desktop manager in dependence upon the user instruction, one of the plurality of virtual desktops to give focus further comprises computer program instructions capable of selecting a virtual desktop that is not the next virtual desktop in the z-axis order in dependence upon a virtual desktop selection rule.

18. The computer program product of claim 14 wherein computer program instructions capable of selecting, by the virtual desktop manager in dependence upon the user instruction, one of the plurality of virtual desktops to give focus further comprises computer program instructions capable of selecting one of the plurality of virtual desktops to give focus in dependence upon mouse pointer location on the display screen.

19. The computer program product of claim 14 wherein the invocation by a user of one or more mouse buttons includes depressing one or more of the mouse buttons for a threshold period of time.

20. The computer program product of claim 14 wherein the invocation by a user of one or more mouse buttons includes a predetermined collection of mouse clicks.
